(19) United States
(12) Patent Application Publication
(10) Pub. No.: US 2026/0036460 A1
(43) Pub. Date: Feb. 5, 2026

(54) CONTAINER WITH A SAFETY MEASURING CAP

(71) Applicant: King Technology, Inc., Minnetonka, MN (US)

(72) Inventors: Crystal Dvorak, Minnetonka, MN (US); Robert Granlund, New Brighton, MN (US); Kayla Hagan, Chaska, MN (US); Daniel P. Longhenry, Bloomington, MN (US); Jeffery Johnson, Edina, MN (US); Darrin M. Swagel, Minnetonka, MN (US)

(21) Appl. No.: 19/241,729

(22) Filed: Jun. 18, 2025

Related U.S. Application Data
(63) Continuation-in-part of application No. 29/954,984, filed on Jul. 30, 2024.

(51) Int. Cl. G01F 23/02; B65D 41/26; B65D 50/04

(52) U.S. Cl. CPC G01F 23/02; B65D 41/26; B65D 50/041

(57) ABSTRACT

A container for holding a material including a container body, a measuring cup, which when inverted, forms a cap configured to couple with the container body for closing the container. The measuring cup includes an outer cup, an inner cup, and a base. An inner cup wall defining an inner chamber interior to the inner cup wall, and an outer cup wall defining an outer chamber between the outer cup wall and the inner cup wall. Written indicia located at multiple heights of the outer cup wall listing volume measurements corresponding to the volume contained within the inner chamber and outer chamber at each of the multiple heights.

### TECHNICAL FIELD

This disclosure relates generally to containers for holding fluid or solid materials, and in particular, the disclosure relates to a container and a removable measuring cap.

### BACKGROUND

Conventional containers designed to hold a fluid or a solid material, typically include a cap configured to be threaded onto a bottle or container. However, in cases involving potentially hazardous materials, such as, prescription medications, household chemicals, pool chemicals, or the like, a child resistant cap may be required. “Child resistant” can mean that the cap may be difficult to remove from the container and/or the cap has passed performance tests with respect to a degree or level of difficulty in removing the cap from the container.

Further, in use, a specific amount of the fluid or solid material (e.g., granular materials) may be required. Such as, for example, a specific medication dosage, a specific amount of a pool chemical, or the like. In such cases, a measuring cup may be required. In view of this, improved safety measuring caps are desired.

### SUMMARY

In general, the present disclosure relates to support structures for solar arrays within a solar tracking system. In a first example, a container for holding a liquid or solid material may include a container body having a closed base section and an open top section, the closed base section being cylindrical with a base section diameter, the open top section having a threaded exterior and being cylindrical with an open top section diameter, the open top section diameter being less than the base section diameter. The container may include a measuring cup, when inverted, forms a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the inner cup wall defining an inner chamber interior to the inner cup wall, and the outer cup wall defining an outer chamber between the outer cup wall and the inner cup wall, the inner cup wall having a channel or passageway connecting the inner and outer chambers, the channel or passageway permitting material within the measuring cup to flow back and forth between the outer chamber and the inner chamber, a lowest height of the channel or passageway being at a channel height upward from the base, an inner surface of the inner cup wall having threads for engaging the threaded exterior of the open top, the threads extending a thread height above the base, and written indicia located at multiple heights of the outer cup wall listing volume measurements corresponding to the volume contained within the inner chamber and outer chamber at each of the multiple heights, the written indicia including a lowermost one of the written indicia closest to the base at a lowermost indicia height above the base, the lowermost indicia height being greater than the channel height and less than the thread height.

Additionally or alternatively, the open top section may include an exterior locking protrusion.

Additionally or alternatively, the outer cup wall may include an interior locking protrusion configured to engage with the exterior locking protrusion to provide a child resistant mechanism whereby the interior locking protrusion and exterior locking protrusion cooperate to permit the inner cup to be threadably engaged with the open top section and preventing the inner cup from being threadably disengaged from the open top section.

Additionally or alternatively, the outer cup wall may be resilient thereby permitting the outer cup wall portion to be squeezed toward the container body.

Additionally or alternatively, the outer cup wall may be resilient thereby permitting the outer cup wall portion to be squeezed toward the container body, the squeezing moving the inner protrusion outward to a position where the exterior locking protrusion does not sufficiently engage with the interior locking protrusion to prevent rotation when the inner cup wall portion is rotated thereby threadably disengaging from the open top section to thereby permit rotation of the cap.

Additionally or alternatively, the outer cup wall may be semi-transparent to see the written indicia vs. the height of the material in the cap.

Additionally or alternatively, the written indicia may include volume measurements in a range of ⅛ cup to 1 cup.

Additionally or alternatively, the written indicia volume measurement of ½ tablespoon may be the lowermost one of the written indicia closest to the base and is higher than the channel height.

Additionally or alternatively, a portion of an inner side of the base of the measuring cup may engage with the open top section of the container body when the measuring cup is inverted to form a seal between the cap and an interior volume of the container body.

Additionally or alternatively, an outer side of the base of the measuring cup may include multiple co-planar points of contact to stabilize the measuring cup when resting on a flat surface.

Additionally or alternatively, the outer cup may include a squeeze point positioned at a location 90 degrees from the interior locking protrusion and the exterior locking protrusion when the inner cup is threadably engaged with the open top section.

In another example, a child resistant container for holding a liquid or solid material may include a container body having a closed base section and an open top section, the closed base section being cylindrical and having a base section diameter at a transition point height where the base section begins to transition to the open top section, the open top section having a threaded exterior and being cylindrical with an open top section diameter, the open top section diameter being less than the base section diameter, the open top section having an exterior locking protrusion. The container may also include a measuring cup, when inverted, forming a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the outer cup wall having a first outer cup wall portion and a second outer cup wall portion, the second outer cup wall portion defines a second outer cup wall portion diameter, the outer cup wall being resilient and having an interior locking protrusion. When the when inner cup is threadably engaged with the open top section: the first outer cup wall portion extends over the open top section and the second outer cup wall portion extends over the transition point, the second outer cup wall portion diameter being at least ⅛″ greater than the base section diameter, the interior locking protrusion and exterior locking protrusion providing a child resistant mechanism, the interior locking protrusion and exterior locking protrusion cooperating to permit the inner cup to be threadably engaged with the open top section and preventing the inner cup from being threadably disengaged from the open top section, the exterior locking protrusion engaging with the interior locking protrusion when the inner cup wall portion is rotated towards threadably disengaging from the open top section to thereby prevent rotation, and the resilience of the outer cup wall permitting the second outer cup wall portion to be squeezed toward the transition point, the squeezing moving the inner protrusion outward to a position where the exterior locking protrusion does not sufficiently engage with the interior locking protrusion to prevent rotation when the inner inner cup wall portion is rotated towards threadably disengaging from the open top section to thereby permit rotation.

Additionally or alternatively, the outer cup may include a squeeze point positioned at a location 90 degrees from the interior locking protrusion and the exterior locking protrusion when the inner cup is threadably engaged with the open top section.

Additionally or alternatively, written indicia may be located at multiple heights of the outer cup wall listing volume measurements corresponding to the volume contained within the inner chamber and outer chamber at each of the multiple heights.

Additionally or alternatively, the written indicia may include volume measurements in a range of ½ tablespoon to 5 tablespoons.

Additionally or alternatively, the outer cup wall may be semi-transparent to see the written indicia vs. the height of the material in the cap.

In another example, a container for holding a liquid or solid material may include a container body having a closed base section and an open top section, the closed base section being cylindrical and having a base section diameter, and a measuring cup, when inverted, forming a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the base providing stability for resting the measuring cup on a flat surface, the base having curved rockers on opposing sides of the base, each curved rocker having a lowermost extent defining a rocker lower surface, the base have a central surface at least partially between the curved rockers, the central surface being at the lower most extent of the base, the rocker lower surface and the central surface being coplanar to stabilize the measuring cup when resting on a flat surface.

Additionally or alternatively, written indicia may be located at multiple heights of the outer cup wall listing volume measurements corresponding to the volume contained within the inner chamber and outer chamber at each of the multiple heights.

Additionally or alternatively, a portion of an inner side of the base of the measuring cup may engage with the open top section of the container body when the measuring cup is inverted to form a seal between the cap and an interior volume of the container body.

Additionally or alternatively, the outer cup wall may be resilient thereby permitting the outer cup wall portion to be squeezed toward the container body.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is perspective view of an example container in accordance with the present disclosure;

FIG. 2 is a front side view of the example container as in FIG. 1;

FIG. 3 is a front side view of an example container body;

FIG. 4A is a cross-sectional view of the example container as in FIG. 2, taken at line 4;

FIG. 4B is an enlarged view of the cross-sectional view of the example container shown in Circle 4B in FIG. 4A;

FIG. 5A is a perspective view of a measuring cup of the example container as in FIG. 1;

FIG. 5B is side view of the measuring cup of the example container as in FIG. 1;

FIG. 5C is a bottom side view of the measuring cup of the example container as in FIG. 1;

FIG. 6A is a front side view of the measuring cup of the example container as in FIGS. 5A to 5C, showing a first written indicia;

FIG. 6B is a rear side view of the measuring cup of the example container as in FIGS. 5A to 5C, showing a second written indicia;

FIG. 7A is a front side perspective view of the measuring cup of the example container as in FIGS. 6A to 6B;

FIG. 7B is a cross-sectional view of the measuring cup of the example container as in FIG. 7A, taken at line 7B;

FIG. 8A is a side view of the measuring cup of the example container as in FIGS. 7A to 7B, shown on a flat surface;

FIG. 8B is a cross-sectional view of the measuring cup of the example container as in FIG. 8A, taken at line 8B, shown on a flat surface;

FIG. 9A is a front side perspective view of another example measuring cup of the example container;

FIG. 9B is a cross-sectional view of the measuring cup of the example container as in FIG. 9A, taken at line 9B; and

FIG. 10 is front side view of a measuring cup of the example container shown in transparent.

### DETAILED DESCRIPTION

The following detailed description is to be read with reference to the drawings, in which like elements in different drawings have like reference numerals. The drawings, which are not necessarily to scale, depict selected embodiments and are not intended to limit the scope of the invention. Skilled artisans will recognize that the examples provided herein have many useful alternatives that fall within the scope of the invention.

In the present specification, anywhere the terms “comprising” or “comprises” are used, those terms have their ordinary, open-ended meaning. In addition, where appropriate, the disclosure at each such location is to be understood to also disclose that it may, as an alternative, “consist essentially of” or “consist of.”

Some embodiments provide a container 10 including a container body 12 and a measuring cup 20, that when inverted, forms a cap 22 configured to couple with the container body 12 for closing the container 10. The container 10 may be configured to hold a material such as a liquid or a solid (e.g., granular) material, such as, for example, pool and spa chemicals, household and industrial cleaners, dishwashing detergents, laundry detergents, pharmaceuticals, industrial fluids, etc.

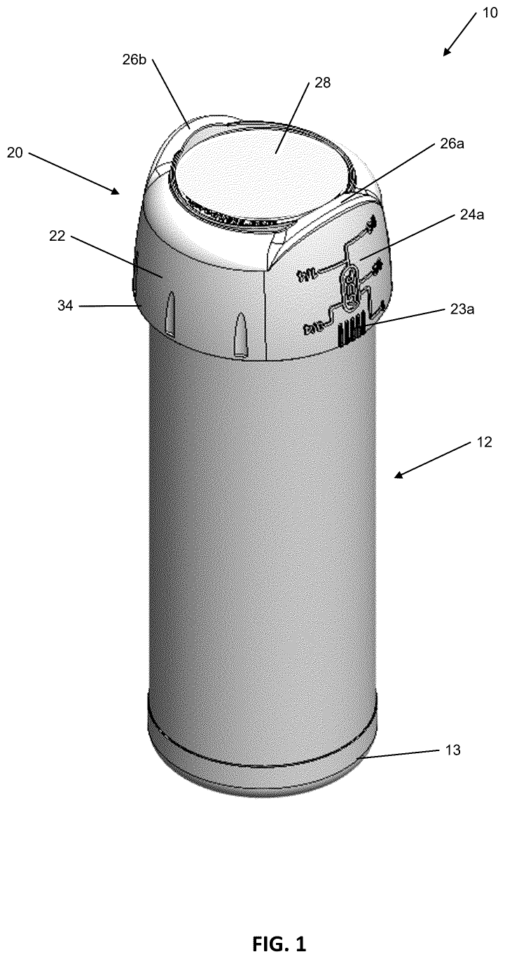

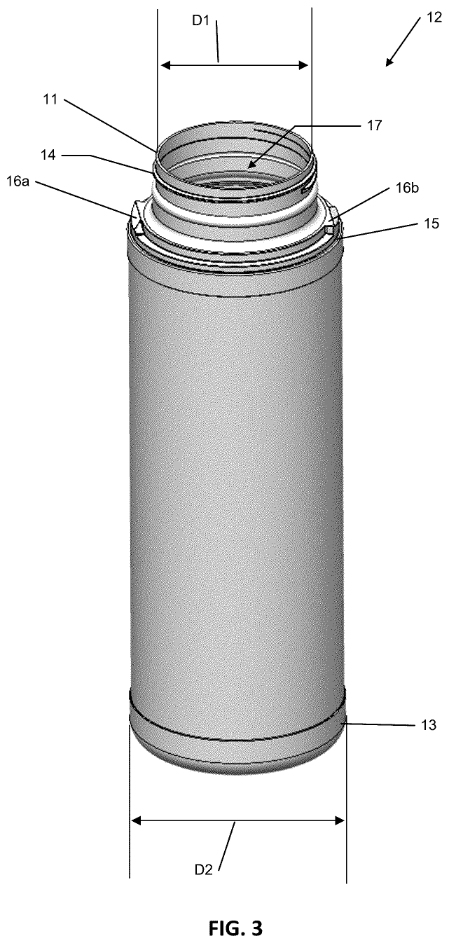

Referring to FIGS. 1 to 3, the container 10 may include the container body 12 having a closed base section 13 and an open top section 11 (FIG. 3) open to an interior volume 17 therein. The open top section 11 may include one or more external threads 14 and may include a cylindrical cross-section. The open top section 11 may include an open top section diameter D₁, as shown in FIG. 3. In some cases, the closed base section 13 may include a cylindrical cross-section with a base section diameter D₂, as shown in FIG. 3. The base section 13 may include a transition point 15 in which the base section 13 begins to transition to the open top section 11. As shown in FIG. 3, the base section diameter D₂, at a transition point 15 height, may be where the base section 13 begins to transition to the open top section 11 and narrow to the open top section diameter D₁. In some examples, the open top section diameter D₁ may be less than the base section diameter D₂, as illustrated in FIG. 3. While it is illustrated that the base section 13 includes a cylindrical cross-section, it may be contemplated that the base section 13 may include a square cross-section, an oval cross-section, a triangular cross-section, a polygonal cross-section, or the like. In some cases, the base section 13 may include a cross-section other than cylindrical while the open top section 11 includes a cylindrical cross-section.

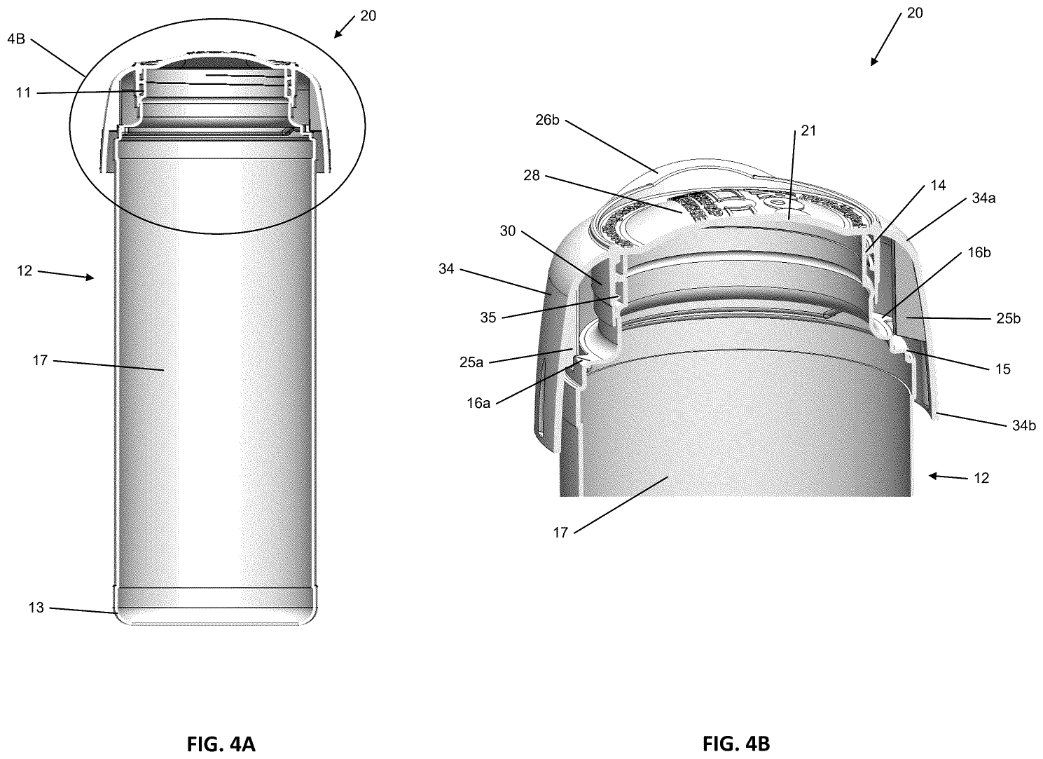

The open top section 11 of the container body 12 may further include one or more exterior locking protrusions 16a, 16b. The one or more exterior locking protrusions 16a, 16b may be configured to engage with one or more interior locking protrusions 25a, 25b of the measuring cup 20, shown in further detail in FIG. 4B. The engagement of the exterior locking protrusions 16a, 16b and the interior locking protrusions 25a, 25b, provide the container 10 with a safety cap, thereby forming a child resistant container.

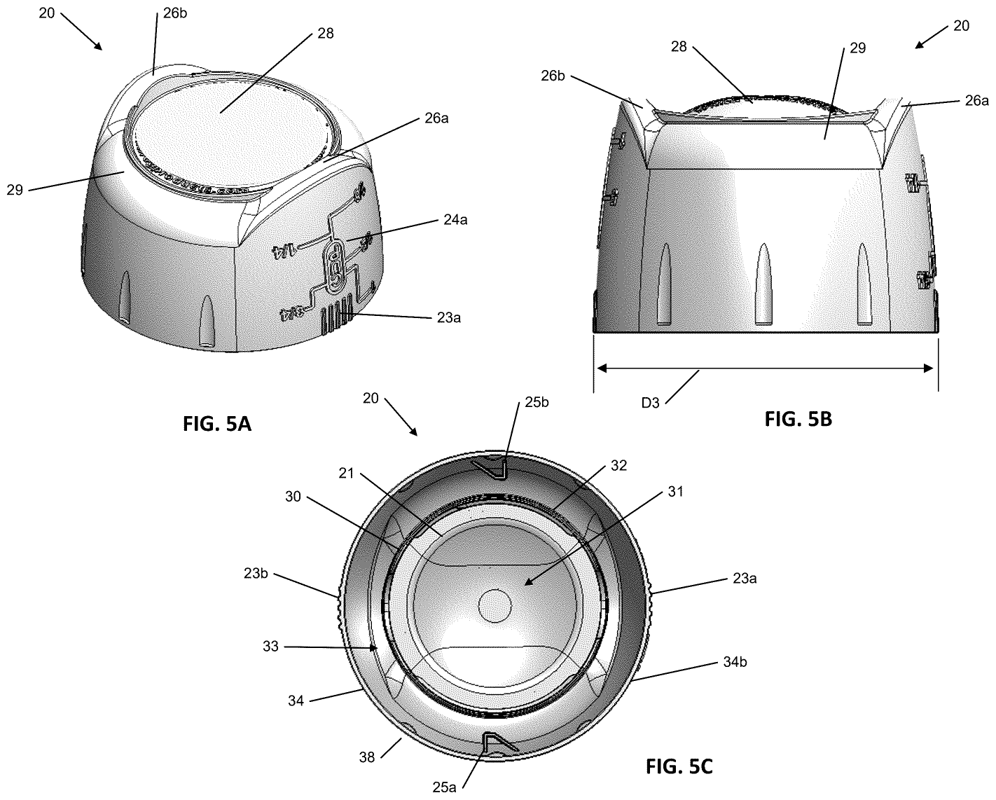

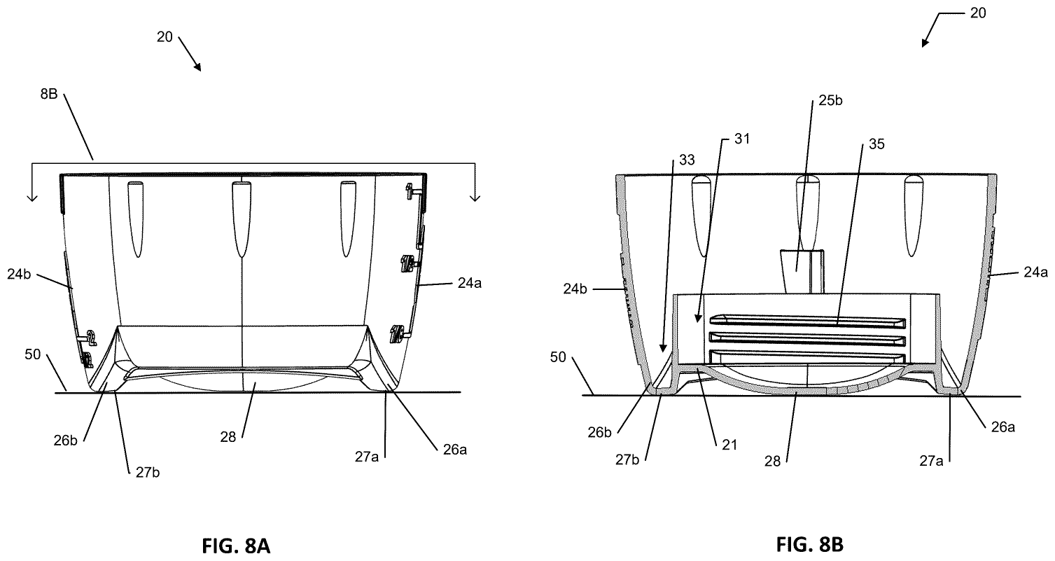

The container 10 may further include a measuring cup 20. The measuring cup 20, when inverted, may form a cap 22 configured to couple with the container body 12 for closing the container 10. The measuring cup 20 may include an outer cup, an inner cup, and a base 29, as will be shown in further detail with reference to FIGS. 5A to 5C. The base 29 may include first and second curved rockers on opposing sides of the base 29. The first curved rocker 26a and the second curved rocker 26b may each include a lowermost extent defining a rocker lower surface 27a, 27b, respectively. The base 29 may further include a central surface 28 at least partially between the curved rockers 26a, 26b. The central surface 28 being at the lower most extent of the base 29. The rocker lower surfaces 27a, 27b and the central surface 28 may be coplanar to stabilize the measuring cup 20 when resting on a flat surface, as shown in further detail in FIGS. 8A to 8B.

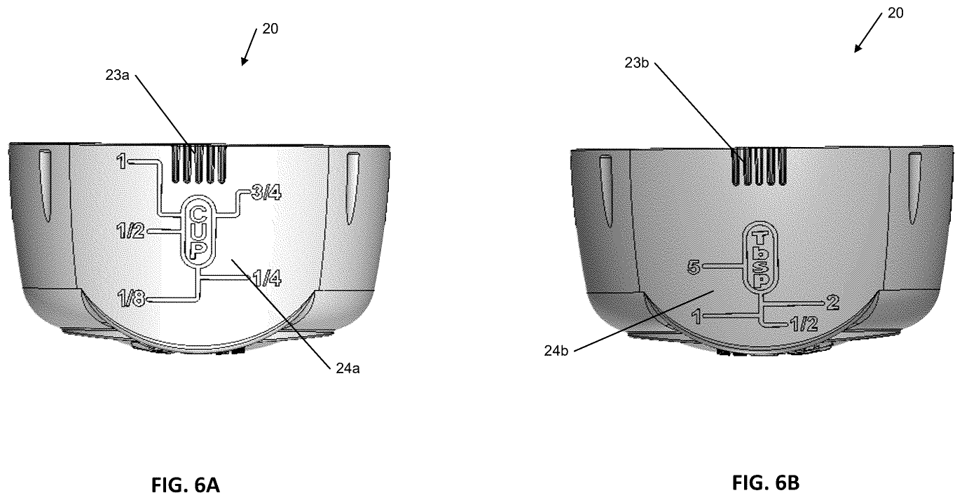

The measuring cup 20 may include a first written indicia 24a and a second written indicia 24b (FIG. 6B), generally referred to herein as written indicia 24, located at multiple heights of an outer cup wall 34, listing volume measurements corresponding to a volume contained within the measuring cup 20. The written indicia 24 may include a lowermost one of the written indicia 24 closest to the base 29 at a lowermost indicia height above the base 29.

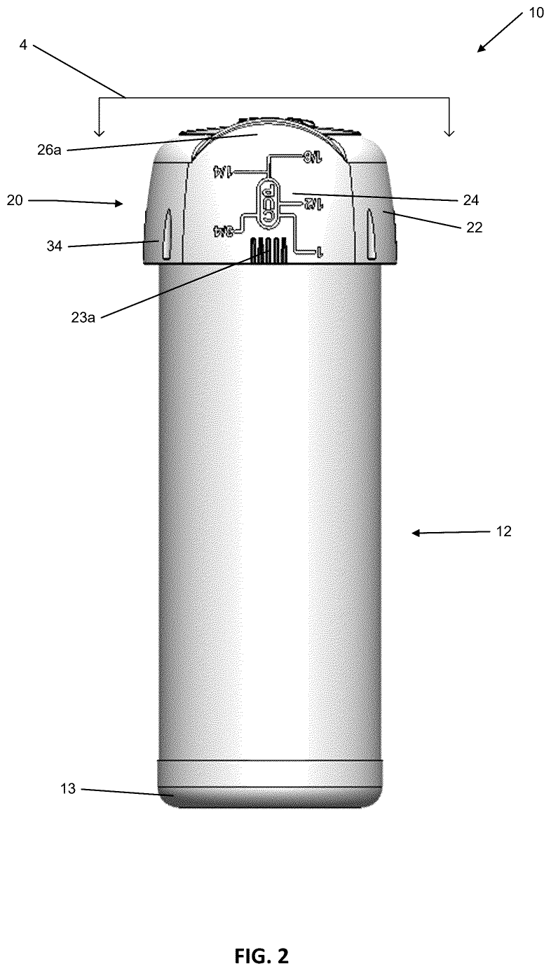

FIG. 4 is a cross-sectional view of the container 10 as in FIG. 2, taken at line 4-4 and FIG. 4B is an enlarged view of a portion of the container 10 shown in Circle 4B in FIG. 4A. As shown in FIGS. 4A and 4B, the measuring cup 20 may include an outer cup wall 34 and an inner cup wall 30. The inner cup wall 30 may define an inner cup 32 (FIG. 5C) and the outer cup wall 34 may define an outer cup 38 (FIG. 5C) positioned between the inner cup wall 30 and the outer cup wall 34. The inner cup wall 30 may include one or more internal threads 35 configured to engage with the one or more external threads 14 of the open top section 11 of the container body 12. When the inner cup 32 is threadably engaged with the open top section 11, a first outer cup wall portion 34a may extend over the open top section 11, and a second outer cup wall portion 34b extends over the transition point 15. The second outer cup wall portion 34b may include a diameter (D₃ shown in FIG. 5B) being at least ⅛″ greater than the base section diameter D₂.

The outer cup wall 34 may include the interior locking protrusions 25a, 25b configured to engage with the exterior locking protrusions 16a, 16b of the container body 12 to provide a child resistant mechanism, whereby the interior locking protrusions 25a, 25b and the exterior locking protrusions 16a, 16b cooperate to permit the inner cup 32 to be threadably engaged with the open top section 11, and preventing the inner cup 32 from being threadably disengaged from the open top section 11. Further, a portion of an inner side 21 of the base 29 of the measuring cup 20 may be configured to engage with the open top section 11 of the container body 12 when the measuring cup 20 is inverted, to form a seal between the cap 22 and the interior volume 17 of the container body 12.

The measuring cup 20 may be formed from a pliable or a resilient material. Such as, for example, polytetrafluoroethylene (PTFE), silicone, polyurethane, other polymers, or the like. The resilience of the outer cup wall 34 may permit the second outer cup wall portion 34b to be squeezed, at a squeeze point 23a, 23b, toward the transition point 15. The squeezing of the squeeze point 23a, 23b may move the interior locking protrusions 25a, 25b outward to a position where the exterior locking protrusions 16a, 16b does not sufficiently engage with the interior locking protrusions 25a, 25b, respectively, to prevent rotation. While squeezing the squeeze point 23a, 23b, the inner cup wall 30 may be rotated towards threadably disengaging from the open top section 11 to thereby permit rotation of the measuring up 20, thereby allowing removal of the measuring cup 20 from the container body 12. In some examples, the squeeze point 23a, 23b of the outer cup wall 34 may be positioned at a location of about 90 degrees from the interior locking protrusions 25a, 25b and the exterior locking protrusions 16a, 16b, when the inner cup wall 30 is threadably engaged with the open top section 11.

FIG. 5A is a perspective view of the measuring cup 20, FIG. 5B is side view of the measuring cup 20, and FIG. 5C is a bottom side view of the measuring cup 20. As discussed with reference to FIGS. 1 to 3, the measuring cup 20 may include an outer cup 38, an inner cup 32, and a base 29. The outer cup 38 may include the outer cup wall 34 which may extend upward from the base 29. The inner cup 32 may include the inner cup wall 30 which may extend upward from the base 29 and may be positioned interior to the outer cup wall 34. The inner cup wall 30 may define an inner chamber 31 interior to the inner cup wall 30, and the outer cup wall 34 may define an outer chamber 33 between the outer cup wall 34 and the inner cup wall 30.

The inner cup 32 of the measuring cup 20 may include a cylindrical cross-section to permit the one or more internal threads 35 to threadably engage with the one or more external threads 14 of the open top section 11. The outer cup 38 of the measuring cup 20 may also include a cylindrical cross-section. In some examples, it may be contemplated that the outer cup 38 may include a square cross-section, an oval cross-section, a triangular cross-section, a polygonal cross-section, or the like, while the inner cup 32 maintains a cylindrical cross-section. In cases when the outer cup 38 includes a cross-section other than cylindrical, the outer cup 38 must maintain a distance from the transition point 15 of the container body 12 to permit squeezing of the squeeze points 23a, 23b.

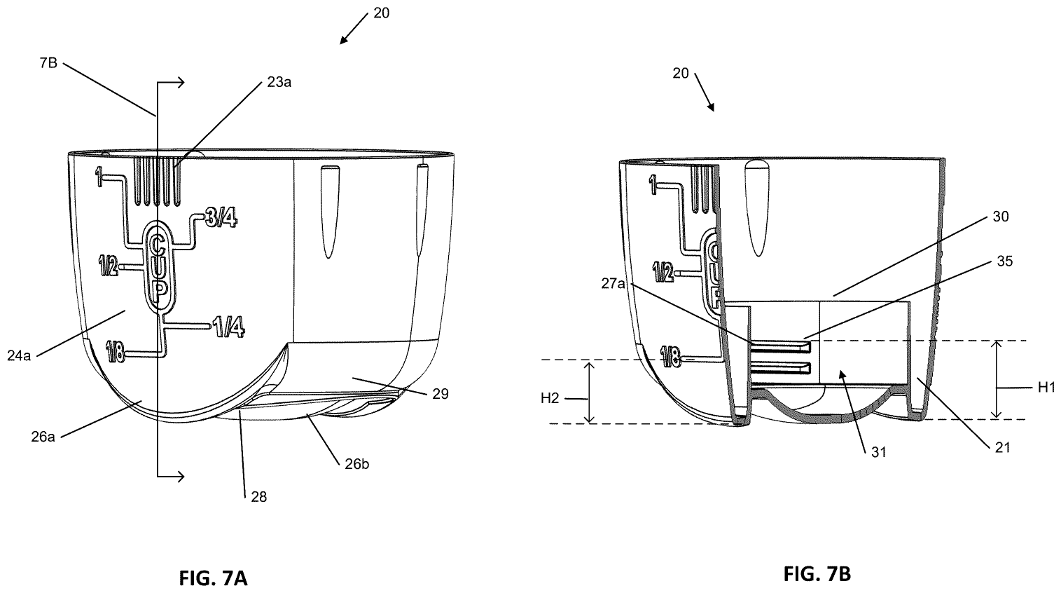

FIG. 6A is a front side view of the measuring cup 20 showing the first written indicia 24a, and FIG. 6B is a rear side view of the measuring cup 20 showing the second written indicia 24b. The written indicia may be located at multiple heights of the outer cup wall 34, listing volume measurements corresponding to the volume contained within the inner chamber 31 and the outer chamber 33 at each of the multiple heights. For example, the first written indicia 24a may include volume measurements in a range of ⅛ cup to 1 cup. The second written indicia 24b may include volume measurements in a range of ½ tablespoon to 5 tablespoons. In some examples, the written indicia 24 may include a lowermost one of the written indicia closest to the base 29 at a lowermost indicia height (shown in FIG. 7B) above the base 29. For example, the written indicia volume measurement of ½ tablespoon may be the lowermost one of the written indicia 24 closest to the base 29. While the written indicia 24 is shown as ⅛ cup to 1 cup or ½ tablespoon to 5 tablespoons, it may be contemplated that the written indicia 24 may include any other volume measurement as desired.

FIG. 7A is a front side perspective view of the measuring cup 20, and FIG. 7B is a cross-sectional view of the measuring cup 20 taken at line 7B-7B. The inner side 21 of the inner cup wall 30 may include the internal threads 35 for engaging the threaded exterior of the open top section 11. The internal threads 35 may extend a thread height H₁ above the base 29, and the written indicia 24 may include the lowermost one of the written indicia closest to the base 29 at a lowermost indicia height H₂ above the base 29. In some examples, the lowermost indicia height H₂ may be greater than or less than the thread height H₂. In some examples, the inner cup wall 30 may include an aperture, e.g., an opening, a hole, a slit, a gap, or the like, that may extend between the inner chamber 31 and the outer chamber 33. The aperture may permit material (fluid and/or granules) within the measuring cup 20 to flow back and forth between the outer chamber 33 and the inner chamber 31. In such examples, the material within the measuring cup may fill the inner chamber 31 and the outer chamber 33 until a volume of material reaches the desired written indicia 24, indicating the desired volume measurement.

FIG. 8A is a side view of the measuring cup 20, and FIG. 8B is a cross-sectional view of the measuring cup 20 as in FIG. 8A, taken at line 8B-8B, showing the measuring cup 20 on a flat surface 50. In some examples, as shown, an outer side of the base 29 of the measuring cup 20 may include multiple co-planar points of contact to stabilize the measuring cup 20 when resting on the flat surface 50. For example, the base 29 may include the first curved rocker 26a and the second curved rocker 26b, generally referred to herein as curved rockers 26, on opposing sides of the base 29. Each curved rocker 26 may include a lowermost extent defining a rocker lower surface 27a, 27b, respectively. The base 29 may include the central surface 28 at least partially between the curved rockers 26. The central surface 28 being at the lower most extent of the base 29. In some examples, the rocker lower surfaces 27a, 27b and the central surface 28 may be coplanar to stabilize the measuring cup 20 when resting on the flat surface 50.

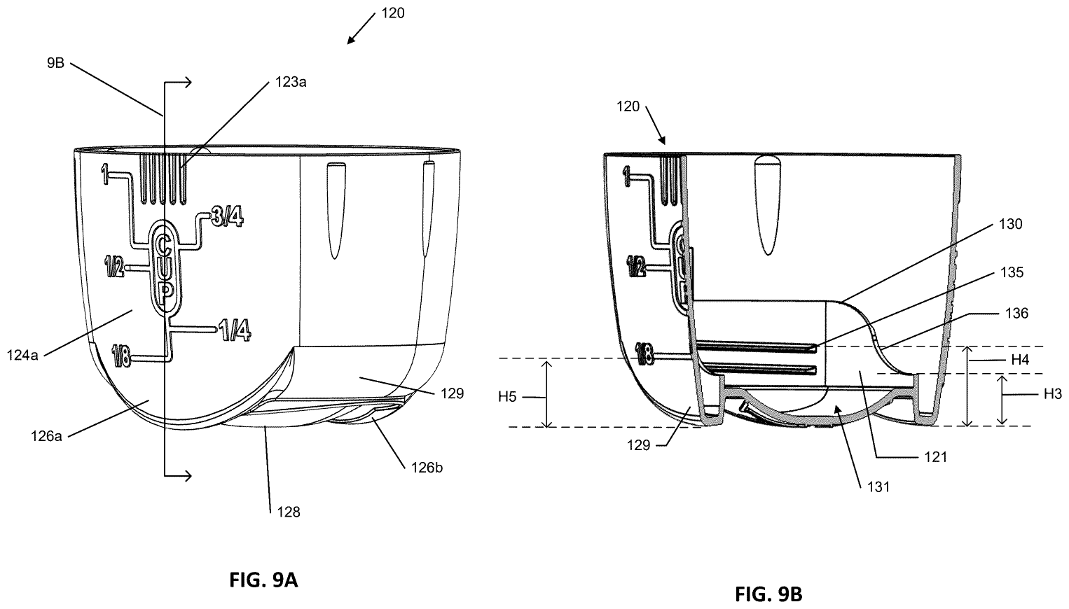

FIG. 9A is a front side perspective view of another example measuring cup 120, and FIG. 7B is a cross-sectional view of the measuring cup 120 taken at line 9B. The measuring cup 120 may be considered as an example of the measuring cup 20, but the measuring cup 120 includes an inner cup wall 130 having a first channel or passageway 136a and a second channel or passageway 136b, generally referred to herein as channel 136, connecting an inner chamber 131 and an outer chamber 133. The channel 136 may permit material (fluid and/or granules) within the measuring cup 120 to flow back and forth between an outer chamber 133 and an inner chamber 131. The lowest height of the channel 136 may be at a channel height H₃ upward from a base 129.

An inner side 121 of the inner cup wall 130 may include internal threads 135 for engaging the threaded exterior of the open top section 11. The internal threads 135 may extend a thread height H₄ above the base 129, and a written indicia 124 may include the lowermost one of the written indicia closest to the base 129 at a lowermost indicia height H₅ above the base 129. In some examples, the lowermost indicia height H₅ may be greater than the channel height H₃ and less than the thread height H₄.

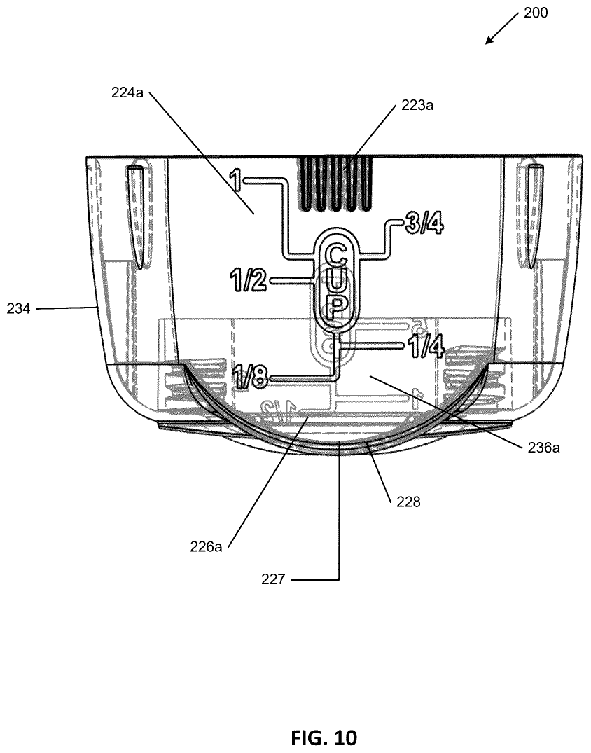

FIG. 10 is front side view of a measuring cup 200 in accordance with the disclosure. The measuring cup 200 may be considered as an example of the measuring cup 20, but the measuring cup 200 is shown as semi-transparent. In some examples, an outer cup wall 234 may be semi-transparent to see a written indicia 224a versus the height of the material in the measuring cup 200 through the outer cup wall 234 of the measuring cup 200.

Various non-limiting exemplary embodiments have been described. It will be appreciated that suitable alternatives are possible without departing from the scope of the examples described herein.

1. A child resistant container for holding a liquid or solid material, comprising:
a container body having a closed base section and an open top section, the closed base section being cylindrical and having a base section diameter at a transition point height where the base section begins to transition to the open top section, the open top section having a threaded exterior and being cylindrical with an open top section diameter, the open top section diameter being less than the base section diameter, the open top section having an exterior locking protrusion;
a measuring cup, when inverted, forming a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the outer cup wall having a first outer cup wall portion and a second outer cup wall portion, the second outer cup wall portion defines a second outer cup wall portion diameter, the outer cup wall being resilient and having an interior locking protrusion;
when the when inner cup is threadably engaged with the open top section: the first outer cup wall portion extends over the open top section and the second outer cup wall portion extends over the transition point, the second outer cup wall portion diameter being at least ⅛″ greater than the base section diameter;
the interior locking protrusion and exterior locking protrusion providing a child resistant mechanism, the interior locking protrusion and exterior locking protrusion cooperating to permit the inner cup to be threadably engaged with the open top section and preventing the inner cup from being threadably disengaged from the open top section, the exterior locking protrusion engaging with the interior locking protrusion when the inner cup wall portion is rotated towards threadably disengaging from the open top section to thereby prevent rotation; and
the resilience of the outer cup wall permitting the second outer cup wall portion to be squeezed toward the transition point, the squeezing moving the inner protrusion outward to a position where the exterior locking protrusion does not sufficiently engage with the interior locking protrusion to prevent rotation when the inner inner cup wall portion is rotated towards threadably disengaging from the open top section to thereby permit rotation.

2. The child resistant container of claim 1, wherein the outer cup includes a squeeze point positioned at a location 90 degrees from the interior locking protrusion and the exterior locking protrusion when the inner cup is threadably engaged with the open top section.

3. The child resistant container of claim 1, wherein written indicia are located at multiple heights of the outer cup wall listing volume measurements corresponding to the volume contained within the inner chamber and outer chamber at each of the multiple heights.

4. The child resistant container of claim 3, wherein the written indicia include volume measurements in a range of ½ tablespoon to 5 tablespoons.

5. The child resistant container of claim 1, wherein the outer cup wall is semi-transparent to see the written indicia vs. the height of the material in the cap.

6. A container for holding a liquid or solid material, comprising:
a container body having a closed base section and an open top section, the closed base section being cylindrical and having a base section diameter; and
a measuring cup, when inverted, forming a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the base providing stability for resting the measuring cup on a flat surface, the base having curved rockers on opposing sides of the base, each curved rocker having a lowermost extent defining a rocker lower surface, the base have a central surface at least partially between the curved rockers, the central surface being at the lower most extent of the base, the rocker lower surface and the central surface being coplanar to stabilize the measuring cup when resting on a flat surface.

7. The container of claim 6, wherein written indicia are located at multiple heights of the outer cup wall listing volume measurements corresponding to the volume contained within the inner chamber and outer chamber at each of the multiple heights.

8. The container of claim 6, wherein a portion of an inner side of the base of the measuring cup engages with the open top section of the container body when the measuring cup is inverted to form a seal between the cap and an interior volume of the container body.

9. The container of claim 6, wherein the outer cup wall is resilient thereby permitting the outer cup wall portion to be squeezed toward the container body.

10. A container for holding a liquid or solid material, comprising:
a container body having a closed base section and an open top section, the closed base section being cylindrical with a base section diameter, the open top section having a threaded exterior and being cylindrical with an open top section diameter, the open top section diameter being less than the base section diameter;
a measuring cup, when inverted, forming a cap configured to couple with the container body for closing the container, the measuring cup having an outer cup, an inner cup, and a base, the outer cup having an outer cup wall extending upward from the base, the inner cup having an inner cup wall extending upward from the base and positioned interior to the outer cup wall, the inner cup wall defining an inner chamber interior to the inner cup wall, and the outer cup wall defining an outer chamber between the outer cup wall and the inner cup wall, the inner cup wall having a channel or passageway connecting the inner and outer chambers, the channel or passageway permitting material within the measuring cup to flow back and forth between the outer chamber and the inner chamber, a lowest height of the channel or passageway being at a channel height upward from the base, an inner surface of the inner cup wall having threads for engaging the threaded exterior of the open top, the threads extending a thread height above the base; and
written indicia located at multiple heights of the outer cup wall listing volume measurements corresponding to the volume contained within the inner chamber and outer chamber at each of the multiple heights, the written indicia including a lowermost one of the written indicia closest to the base at a lowermost indicia height above the base, the lowermost indicia height being greater than the channel height and less than the thread height.

11. The container of claim 10, wherein the open top section includes an exterior locking protrusion.

12. The container of claim 11, wherein the outer cup wall includes an interior locking protrusion configured to engage with the exterior locking protrusion to provide a child resistant mechanism whereby the interior locking protrusion and exterior locking protrusion cooperate to permit the inner cup to be threadably engaged with the open top section and preventing the inner cup from being threadably disengaged from the open top section.

13. The container of claim 10, wherein the outer cup wall is resilient thereby permitting the outer cup wall portion to be squeezed toward the container body.

14. The container of claim 12, wherein the outer cup wall is resilient thereby permitting the outer cup wall portion to be squeezed toward the container body, the squeezing moving the inner protrusion outward to a position where the exterior locking protrusion does not sufficiently engage with the interior locking protrusion to prevent rotation when the inner cup wall portion is rotated thereby threadably disengaging from the open top section to thereby permit rotation of the cap.

15. The container of claim 10, wherein the outer cup wall is semi-transparent to see the written indicia vs. the height of the material in the cap.

16. The container of claim 10, wherein the written indicia include volume measurements in a range of ⅛ cup to 1 cup.

17. The container of claim 16, wherein the written indicia volume measurement of ½ tablespoon is the lowermost one of the written indicia closest to the base and is higher than the channel height.

18. The container of claim 10, wherein a portion of an inner side of the base of the measuring cup engages with the open top section of the container body when the measuring cup is inverted to form a seal between the cap and an interior volume of the container body.

19. The container of claim 10, wherein an outer side of the base of the measuring cup includes multiple co-planar points of contact to stabilize the measuring cup when resting on a flat surface.

20. The container of claim 10, wherein the outer cup includes a squeeze point positioned at a location 90 degrees from the interior locking protrusion and the exterior locking protrusion when the inner cup is threadably engaged with the open top section.
